(19) United States
(12) Patent Application Publication
(10) Pub. No.: US 2017/0038935 A1
(43) Pub. Date: Feb. 9, 2017

(54) INFORMATION PROCESSING DEVICE, INFORMATION DISPLAY METHOD, AND RECORDING MEDIUM

(71) Applicant: NEC Corporation, Tokyo (JP)

(72) Inventor: Hidenaga MATSUSHIMA, Tokyo (JP)

(73) Assignee: NEC Corporation, Tokyo (JP)

(21) Appl. No.: 15/120,642

(22) PCT Filed: Feb. 24, 2015
(86) PCT No.: PCT/JP2015/000890

§ 371 Date: Aug. 22, 2016

(30) Foreign Application Priority Data
Feb. 28, 2014 (JP) 2014-037800

(51) Int. Cl. G06F 3/0485; G06F 17/30; G06F 9/44; G06F 17/22; G06F 3/0482

(52) U.S. Cl. CPC G06F 3/0485; G06F 17/2247; G06F 3/0482; G06F 9/4446; G06F 17/30961; G06F 17/30994

(57) ABSTRACT

To provide a user interface technology to improve the operability for information. An information processing apparatus includes: a category acquisition unit that acquires category information of the plurality of information sets serving as the processing target; a first drawing processing unit that causes the category information to be displayed on the display unit with a tree structure in which at least one category is used as a node; and a second drawing processing unit that causes a plurality of cards indicating a plurality of information sets belonging to a leaf category to be displayed in a stacked form, and causes one of the plurality of information sets belonging to the leaf category to be displayed as a workable card for each leaf category related to a leaf node in the tree structure.

### TECHNICAL FIELD

The present invention relates to an information processing technique of displaying information serving as a processing target individually.

### BACKGROUND ART

Smart devices such as smartphones or tablet terminals are used for the purpose of business in addition to personal use. In applications operating in smart devices, the same graphical user interface (GUI) as that used in stationary personal computers (PCs), such as a tab or a tree view, is still used.

The existing GUI is designated based on the assumption of an operation performed while viewing a display unit having a large display area, that is, an operation based on behavior of an input device such as a mouse or a keyboard (hereinafter, referred to as a “device operation”). Thus, the existing GUI is not suitable for an operation based on behavior of a body of a user or a part thereof (hereinafter, referred to as a “body operation”) such as a touch operation or a gesture operation on a narrow display area. Using the body operation, the user can easily imagine an operation, but it is difficult to deal with a fine motion compared to the device operation.

A technique of improving operability of a scroll bar which is a part of the existing GUI was proposed in PTL 1. In the proposed technique, it is determined whether or not a position on a screen indicated by the user is a position on the scroll bar or a position on a predetermined region around the scroll bard, and the width of the scroll bar is increased according to the determination result.

### CITATION LIST

### Patent Literature

PTL 1: JP 2004-192573 A

### SUMMARY OF INVENTION

### Technical Problem

According to the technique proposed in PTL 1, it is easy to perform the scroll operation. However, there is a problem in that operability of a basic operation of selecting desired information among a lot of information displayed in a form such as a tab display, a list display, or a tree view and editing the selected information is not improved.

Commonly, in the smart device, the display area is narrow, and the body operation serves as a main operation. When the smart device is used for the purpose of business, the smart device is mostly used outside a company office. It is because an existing stationary PC is used in the company office. Further, the smart device is unlikely to be used on a desk because it has high portability. When the existing GUI is employed in such a smart device, since an operation range for accessing desired information is narrow, it is difficult to perform such a basic operation.

The present invention was made in light of the foregoing, and it is an object of the present invention to provide a user interface technique of improving operability on information.

### Solution to Problem

In aspects of the present invention, in order to solve the above-described problems, the following configurations are employed.

The first aspect relates to an information processing apparatus that causes each of a plurality of information sets serving as a processing target to be displayed on a display unit in a card format. The first aspect relating to the information processing apparatus includes: a category acquisition unit that acquires category information of the plurality of information sets serving as the processing target; a first drawing processing unit that causes the category information to be displayed on the display unit with a tree structure in which at least one category is used as a node; and a second drawing processing unit that causes a plurality of cards indicating a plurality of information sets belonging to a leaf category to be displayed in a stacked form, and causes one of the plurality of information sets belonging to the leaf category to be displayed as a workable card for each leaf category related to a leaf node in the tree structure.

The second aspect relates to an information display method executed by at least one computer that causes each piece of information serving as processing target to be displayed on a display unit in a card format. The second aspect relating to the information display method includes: acquiring category information of a plurality of information sets serving as the processing target; causing the category information to be displayed on the display unit with a tree structure in which at least one category is used as a node; displaying a plurality of cards indicating a plurality of information sets belonging to a leaf category in a stacked form for each leaf category related to a leaf node in the tree structure; and displaying one of the plurality of information sets belonging to the leaf category as a workable card for each leaf category.

Another aspect relating to the present invention can be the drawing setting device for setting processes of the above first aspect device; the drawing setting method of the above second aspect method; the information display method of the above second aspect; a program for causing at least one computer to execute a drawing setting method of another aspect; or a computer readable storage media storing the program. The storage media includes non-transitory tangible media.

### Advantageous Effects of Invention

According to the above aspects, it is possible to provide a user interface technique of improving operability on information.

### BRIEF DESCRIPTION OF DRAWINGS

FIG. 1 is a diagram schematically illustrating an exemplary processing configuration of an information processing apparatus in an overview of an exemplary embodiment of the present invention.

FIG. 2 is a flowchart illustrating an exemplary operation of an information processing apparatus in an overview of an exemplary embodiment of the present invention.

FIG. 3 is a diagram schematically illustrating an example of information display in an overview of an exemplary embodiment of the present invention.

FIG. 4 is a diagram schematically illustrating an example of information display in an overview of an exemplary embodiment of the present invention.

FIG. 5 is a diagram schematically illustrating an exemplary hardware configuration of a smart device according to a first exemplary embodiment of the present invention.

FIG. 6 is a diagram schematically illustrating an exemplary processing configuration of the smart device according to the first exemplary embodiment of the present invention.

FIG. 7 is a flowchart illustrating an exemplary operation of the smart device according to the first exemplary embodiment of the present invention.

FIG. 8 is a diagram schematically illustrating an example of a part of information display according to the first exemplary embodiment of the present invention.

FIG. 9 is a diagram schematically illustrating an exemplary processing configuration of a smart device according to a second exemplary embodiment of the present invention.

FIG. 10 is a flowchart illustrating a part of an exemplary operation of the smart device according to the second exemplary embodiment of the present invention.

FIG. 11 is a diagram schematically illustrating an exemplary hardware configuration of a drawing setting device (setting device) according to a third exemplary embodiment of the present invention.

FIG. 12 is a diagram schematically illustrating an exemplary processing configuration of the drawing setting device (setting device) according to the third exemplary embodiment of the present invention.

FIG. 13 is a diagram illustrating an example of an assistance screen in which a second assistance screen is integrated with a third assistance screen.

FIG. 14 is a diagram illustrating an example of an assistance screen in which a second assistance screen is integrated with a third assistance screen.

FIG. 15 is a flowchart illustrating an exemplary operation of the drawing setting device (setting device) according to the third exemplary embodiment of the present invention.

FIG. 16 is a diagram schematically illustrating an exemplary processing configuration of a smart device according to a modified example.

FIG. 17A is a diagram schematically illustrating an example of a part of information display according to a modified example.

FIG. 17B is a diagram schematically illustrating an example of a part of information display according to a modified example.

### DESCRIPTION OF EMBODIMENTS

Hereinafter, an overview of the present invention common to exemplary embodiments of the present invention will be described before the exemplary embodiments are described. The exemplary embodiments to be described below are examples, and the present invention is not limited to configurations of the exemplary embodiments. Further, a user interface technique disclosed in the exemplary embodiments of the present invention is a technique that is widely effective in not only a computer called a smart device but also all information processing apparatus s.

### OVERVIEW

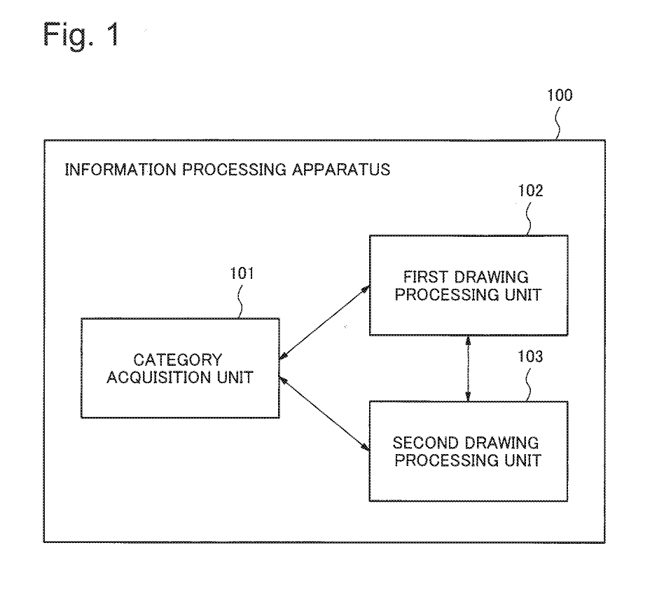

FIG. 1 is a diagram schematically illustrating an exemplary processing configuration of an information processing apparatus 100 according to an exemplary embodiments of the present invention. As illustrated in FIG. 1, the information processing apparatus 100 controls a display unit (not illustrated) such that each piece of information serving as a processing target is displayed in a card format. The information processing apparatus 100 includes a category processing unit 101, a first drawing processing unit 102, and a second drawing processing unit 103. The category acquisition unit 101 acquires category information of a plurality of information sets serving as the processing target. The first drawing processing unit 102 causes the category information to be displayed on the display unit with a tree structure in which a category is used as a node. The second drawing processing unit 103 displays a plurality of cards indicating a plurality of pieces of information belonging to a leaf category in a stacked display form for each leaf category related to a leaf node in the tree structure. Further, the second drawing processing unit 103 causes one of a plurality of pieces of information belonging to the leaf category to be displayed as a workable card.

For example, the information processing apparatus 100 illustrated in FIG. 1 has the same hardware configuration as a smart device 10 in a detailed exemplary embodiment which will be described later, and the respective units of the information processing apparatus 100 are implemented as a program is processed, similarly to the smart device 10. The display unit may be disposed in the information processing apparatus 100 or may be disposed in any other computer (not illustrated) which is connected to be able to communicate with the information processing apparatus 100. The display unit is a device that displays a screen related to drawing data such as a liquid crystal display (LCD) or a cathode ray tube (CRT) display.

Next, an overview of information display method according to exemplary embodiments of the present invention will be described. The information display method according to the exemplary embodiments is performed using at least one computer such as the information processing apparatus 100 so that each piece of information serving as the processing target is displayed on the display unit in the card format. The display unit may be disposed in a computer serving as a main entity of performing the information display method or may be disposed in any other computer (not illustrated) connected to be able to communicate.

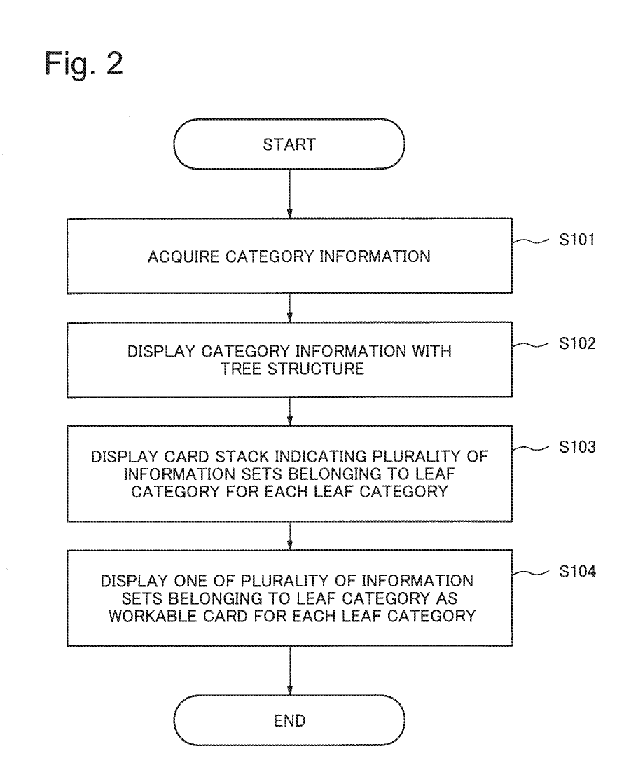

FIG. 2 is a flowchart illustrating an exemplary operation of the information processing apparatus 100 according to the exemplary embodiments of the present invention. First, the category acquisition unit 101 acquires the category information of a plurality of information sets serving as the processing target (step S101). The first drawing processing unit 102 causes the acquired category information to be displayed on the display unit with the tree structure in which the category is used as the node (step S102). The second drawing processing unit 103 displays a plurality of cards indicating a plurality of information sets belonging to the leaf category in a stacked form for each leaf category related to the leaf node in the tree structure (step S103). Further, the second drawing processing unit 103 causes one of a plurality of information sets belonging to the leaf category to be displayed as the workable card for each leaf category (step S104).

An execution order of the processes is not limited to the order illustrated in FIG. 2. For example, step S102, step S103, and step S104 may be performed in parallel. Each of the exemplary embodiments of the present invention may be a program causing a computer to execute the information display method or may be a computer readable recording medium having such a program recorded therein.

In the exemplary embodiments of the present invention, each piece of information serving as the processing target is displayed in the card format (cut format). Here, the displaying in the card format refers to displaying each piece of information in a drawing element having an arbitrary shape such that each piece of information can be independently visually recognized and operated. In other words, a term “card” is a word used for the purpose of convenience of description, and a word itself has no special intension of specifying a shape. A shape of a drawing element for displaying information is not limited and may be a two-dimensional shape or a three-dimensional shape. The shape may be a sheet shape or may be any other shape such as a bubble. Content of information serving as the processing target is not limited. An information unit indicated by a card is not limited. Information indicated by a plurality of cards may overlap. However, when the information unit indicated by a card is a work unit of the user, operability of the user can be further improved. In this description, individual “information” means information indicated by one card. An “information set” means a set of pieces of information.

In the exemplary embodiments of the present invention, the category information of a plurality of information sets serving as the processing target is displayed with the tree structure, and a plurality of cards indicating a plurality of information sets belonging to the leaf category are displayed in the stacked form for each leaf category related to the leaf node in the tree structure. The leaf node refers to a node having no child node in the tree structure. In this regard, the leaf category refers to a category having no category of a lower layer that is further subdivided from the category. A top node is indicated as a “root node,” and a node having a child node other than the root node is indicated as an “intermediate node.” In the present exemplary embodiment, content of the tree structure itself is not limited. For example, the display may be performed with a tree structure having only leaf nodes, a tree structure having a plurality of root nodes, a tree structure in which a top node is a leaf node, or the like according to the category information.

A stack of cards displayed in a stacked display form is referred to as a “card stack.” The display in the stacked display form means that a plurality of cards are viewed by the user as if a plurality of cards are stacked, and a specific display technique is not limited. As an example, the display may be implemented by displaying an image indicating stacked cards. In this display, cards that are equal to the number of existing cards may be stacked and display, or cards may be stacked and displayed so that it is understood whether or not there are a plurality of cards.

As described above, in the exemplary embodiments of the present invention, a plurality of pieces of information having the category information are displayed in two display forms, that is, the tree structure display of the category information and the stacked display of each piece of information. According to the tree structure display, it is possible to indicate a type of a category that exists and a hierarchical relation between categories so that they are easily understood. According to the stacked display of the information, information of the top layer can have a wide display range, and it is possible to indicate the presence of other information through a stack. According to this display technique, compared to the display technique such as the list display or the tab display, the scroll operation can be reduced, an operation range at the time of selection of certain information can be increased, and thus operability of the user can be improved.

In addition, in the exemplary embodiments of the present invention, one of a plurality of information sets belonging to the leaf category is displayed as the workable card for each leaf category. Here, the workable card refers to a card in which a work including an input operation can be performed on information indicated by the card. A non-workable card is displayed to present a part or all of information indicated by the card. However, the non-workable card may have a form in which an auxiliary work can be performed on information indicated by the card.

Thus, the user can perform a work on information indicated by the card by performing a predetermined operation on the workable card. In other words, according to the exemplary embodiments of the present invention, it is possible to increase an operation range for accessing desired information, and compared to the list display, the tree view display, and the like, an operation on information can be easily performed. In other words, according to the exemplary embodiments of the present invention, even in the smart device in which the display area is narrow, and the body operation serves as a main operation, reference and input operations on information can be easily performed.

As described above, according to the exemplary embodiments of the present invention, it is possible to provide the user interface technique capable of improving visibility as a whole of information serving as the processing target, the category information of the information, and a correspondence relation between a category and information and operability on the display thereof as a whole.

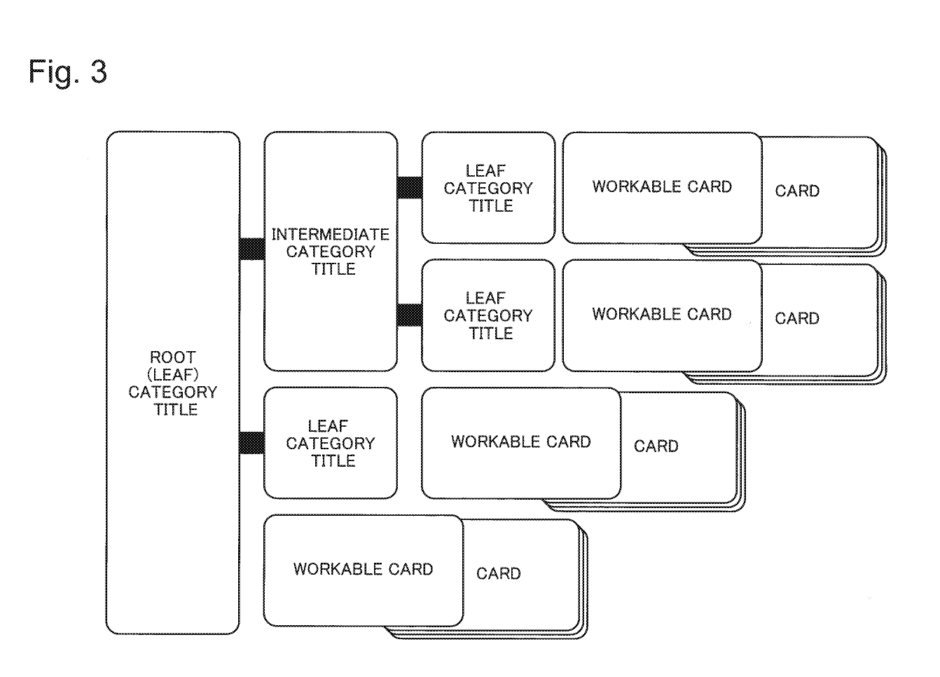

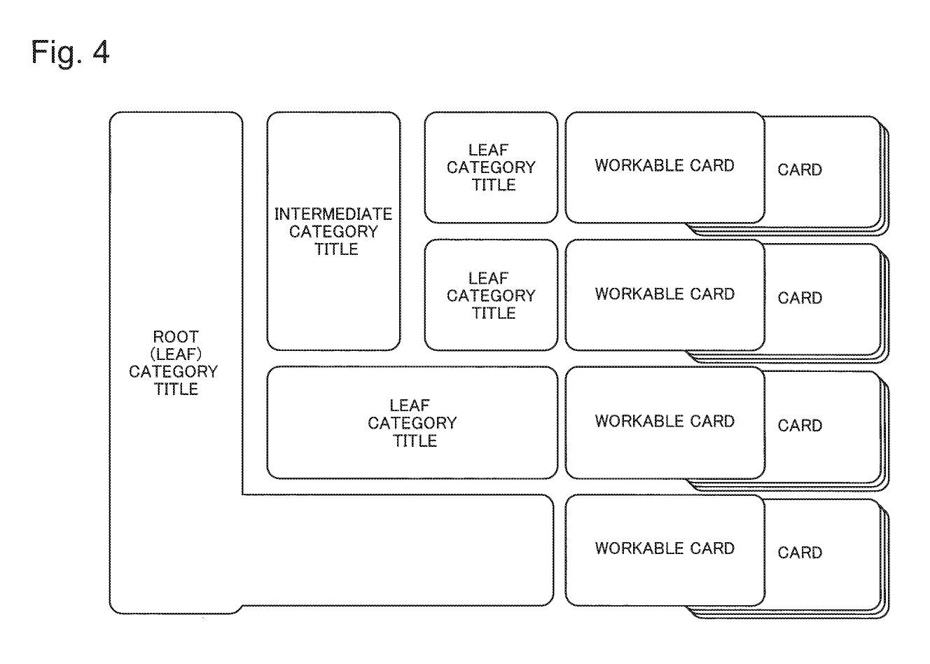

FIGS. 3 and 4 are diagrams schematically illustrating an example of information display displayed on a screen of the display unit in the exemplary embodiments of the present invention. In the screen example of FIG. 3, each card has a rectangular shape having round corners. The workable card is arranged to partially overlap the card stack. A title of a relevant category is displayed on each node of the tree structure of the category information. The intermediate category refers to a category related to the intermediate node, and a root category refers to a category related to the root node. In the screen example of FIG. 3, a top node is indicated as a “root (leaf)” since the top node relates to both of the root node and the leaf node.

Here, a position relation between the workable card and the card stack is not limited to the screen example of FIG. 3. A card of the top layer in the card stack may be the workable card. As in a screen example of FIG. 4, in the tree structure display of the category information, nodes may not be connected by a line. Further, as in the screen example of FIG. 4, the display area of the workable card and the card stack may be separated from the display area of the tree structure of the category information.

Hereinafter, the exemplary embodiments of the present invention will be described in detail. In the following exemplary embodiments, the smart device is used as an example. The above-described overview of the exemplary embodiments and content of the exemplary embodiments which will be described later are applicable to not only the smart device but also all computers capable of executing an application having a GUI. The first and second exemplary embodiments will be described below focusing on different points from the above description. A description of the same content as the overview of the exemplary embodiments of the present invention will be appropriately omitted.

### First Exemplary Embodiment

### Hardware Configuration

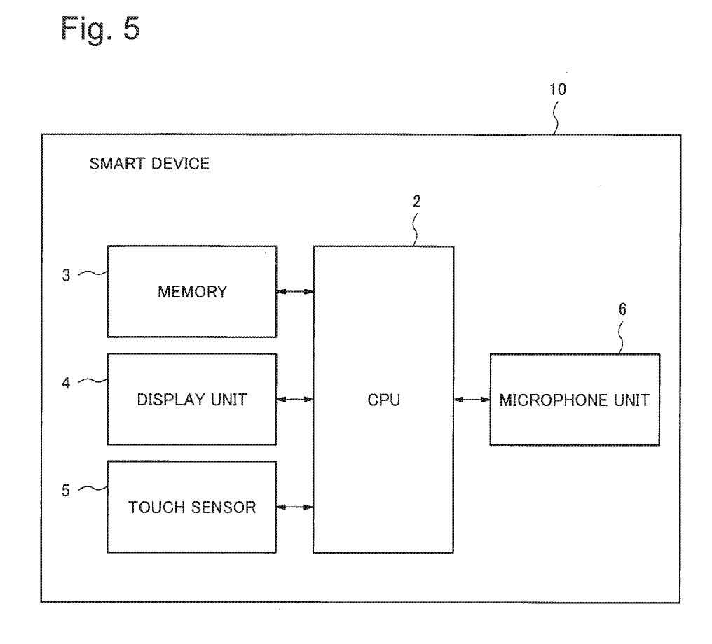

FIG. 5 is a diagram schematically illustrating an exemplary hardware configuration of the smart device 10 according to the first exemplary embodiment. The smart device 10 according to the first exemplary embodiment includes a central processing unit (CPU) 2, a memory 3, a display unit 4, a touch sensor 5, a microphone unit 6, and the like. The hardware configuration of the smart device 10 according to the first exemplary embodiment is an example and not limited to an example of FIG. 5.

The CPU 2 is connected with each unit via a communication line such as a bus. The memory 3 includes a random access memory (RAM), a read only memory (ROM), or an auxiliary storage device (a flash memory or the like). The display unit 4 includes a monitor such as an LCD or a CRT display and performs a display process.

The touch sensor 5 receives an operation input from the user by detecting an external contact. The touch sensor 5 may be a sensor capable of detecting a proximity state from the outside even in a non-contact state. The display unit 4 and the touch sensor 5 may be implemented as a touch panel unit. The smart device 10 may include an imaging unit (not illustrated) that recognizes a gesture or the like together with or instead of the touch sensor 5.

The microphone unit 6 is a sound collection device. In the example of FIG. 5, the touch sensor 5 and the microphone unit 6 are illustrated as hardware elements capable of detecting the user operation, but the smart device 10 may be equipped with a sensor capable of detecting a different type of user operation such as a vibration sensor, an acceleration sensor, or a geomagnetic sensor.

(Processing Configuration)

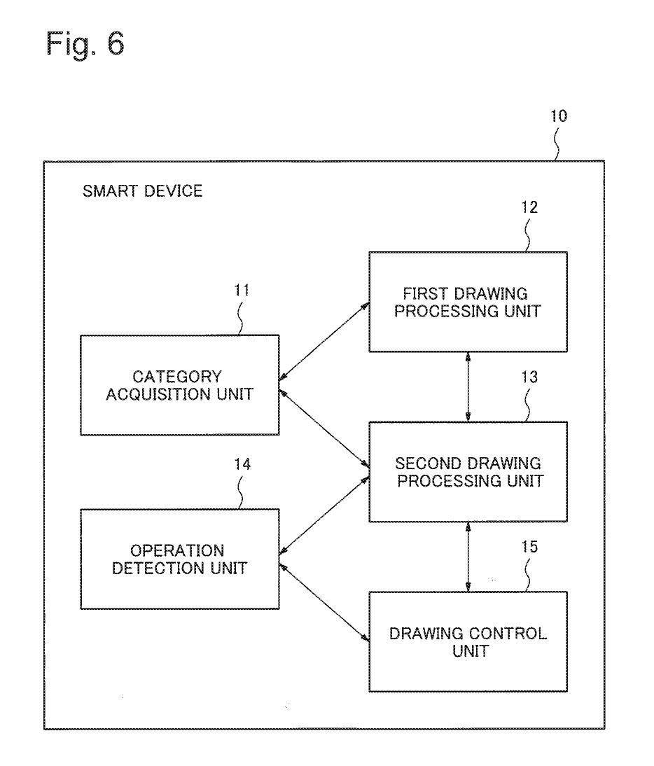

FIG. 6 is a diagram schematically illustrating an exemplary processing configuration of the smart device 10 according to the first exemplary embodiment. The smart device 10 according to the first exemplary embodiment includes a category acquisition unit 11, a first drawing processing unit 12, a second drawing processing unit 13, an operation detection unit 14, a drawing control unit 15, and the like. Each of the processing units is stored, for example, in the memory 3 illustrated in FIG. 5 as a program and implemented by executing the program through the CPU 2 at an appropriate timing. For example, the program may be installed from a portable recording medium such as a memory card or another computer on a network via an input/output I/F or a communication unit (not illustrated) and stored in the memory 3.

The category acquisition unit 11 performs the same process as the category acquisition unit 101. The category information may be stored in the memory 3 in advance, may be input by the user operation on the touch sensor 5, or may be acquired from another computer through communication.

The operation detection unit 14 detects a predetermined operation on the workable card. The detected predetermined operation is an operation serving as a trigger for switching information indicated by the workable card to other information and thus set as an operation indicating a classification (completion, holding, or the like) of a work on information indicated by the card, for example. The predetermined operation may be an operation of pushing a displayed button, a predetermined gesture operation, or a predetermined voice operation. The operation detection unit 14 detects a specific user operation based on information transmitted from the touch sensor 5 or/and the microphone unit 6 illustrated in FIG. 5. As the specific user operation detected by the operation detection unit 14, the above-described predetermined operation on the workable card, that is, the operation (hereinafter, referred to as a “close operation”) serving as a trigger for switching the information indicated by the workable card to other information is included. Further, as the specific user operation, the scroll operation on the tree structure display of the category information is also included.

When the operation detection unit 14 detects the predetermined operation, the drawing control unit 15 causes other information belonging to the same leaf category as the information indicated by the workable card to be newly displayed as the workable card.

The first drawing processing unit 12 relates to the first drawing processing unit 102. The first drawing processing unit 12 causes the category information acquired by the category acquisition unit 11 to be displayed on the display unit 4 with the tree structure in which the category is used as the node. At this time, when the display of the tree structure falls within the display area of the display unit 4, the first drawing processing unit 12 causes a part of the tree structure of the category information to be displayed on the display unit 4. The first drawing processing unit 12 may further display a scroll bar for moving the display range of the tree structure. The first drawing processing unit 12 displays a title of a category related to a node in each node in the tree structure.

The second drawing processing unit 13 associates the title of the leaf category displayed on the display unit 4 with the card stack displayed in association with the leaf category. In other words, when the display position of each node in the tree structure is moved, the second drawing processing unit 13 changes a display position of the card stack to track the moving. For example, when the display range of the tree structure is scrolled, the second drawing processing unit 13 similarly moves each card stack. When a certain node gets out of the display area of the display unit 4 by the scrolling, the second drawing processing unit 13 similarly causes the card stack related to the leaf category associated with the node to get out of the display area.

The second drawing processing unit 13 changes the display form of the card according to the state of the information indicated by the card. Examples of the display form to be displayed include a display position, a display color, and a display shape. For example, the second drawing processing unit 13 can display a card stack of a card indicating information of a work completion state and a card stack of a card indicating information of a work non-completion state, separately. In this case, when the information indicated by the card is the work completion state, the second drawing processing unit 13 changes an arrangement of the card. The second drawing processing unit 13 can change colors or shapes of the card indicating the information of the work completion state and the card indicating the information of the work non-completion state. A state of information serving as a condition under which the display form of the card is changed is not limited. As described above, a state indicating whether or not a work (process) is completed may be used as a condition, or a state indicating whether or not an information flag such as a holding flag is attached may be used as a condition. In the present exemplary embodiment, specific change content of the display form and a specific state of information serving as a change condition are limited.

(Exemplary Operation)

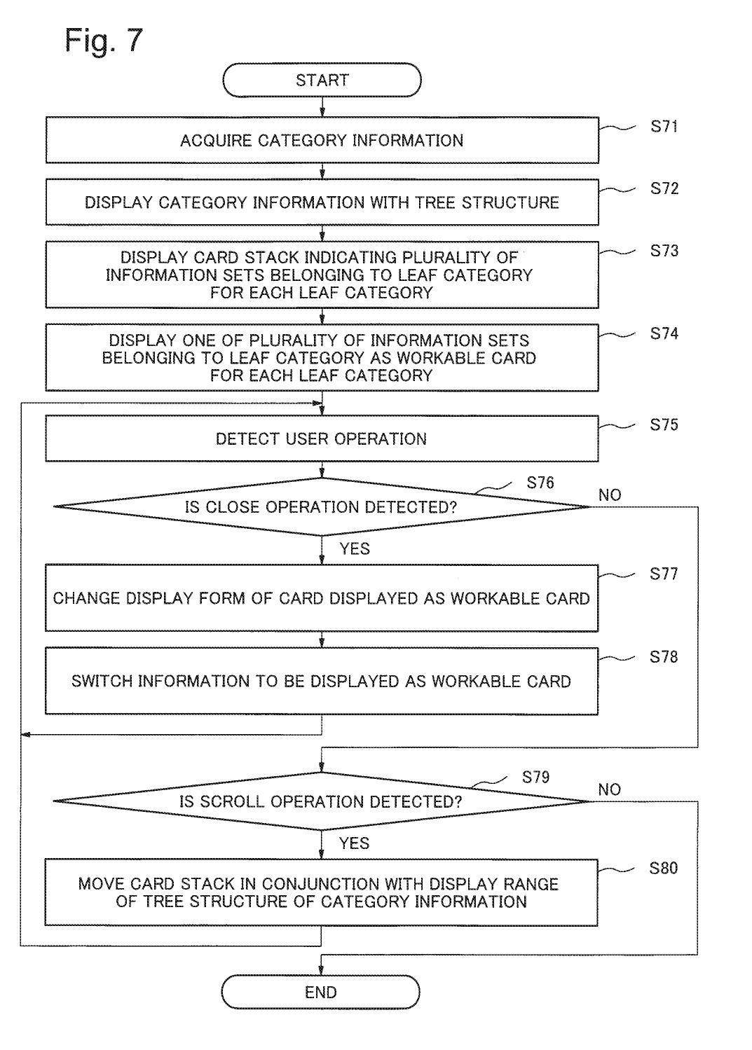

Next, an information display method according to the first exemplary embodiment will be described with reference to FIG. 7. FIG. 7 is a flowchart illustrating an exemplary operation of the smart device 10 according to the first exemplary embodiment. In the following description, an execution entity of each process is the smart device 10, but each process may be performed by a plurality of computers including the smart device 10. Each process is the same as the processing content of the processing units included in the smart device 10, and thus a detailed process will be appropriately omitted.

A process of steps S71 to S74 is the same as steps S101 to S104 illustrated in FIG. 2, and thus a description thereof is omitted.

The operation detection unit 14 of the smart device 10 detects the user operation (step S75). The detected user operation is various operations detected by a common smart device 10 such as the touch operation, the gesture operation, and the voice operation.

When the operation detection unit 14 detects the close operation (YES in step S76), the second drawing processing unit 13 changes the display form of the card displayed as the workable card according to the state of the information indicated by the card (step S77). Examples of the changed display form include a display position, a display color, and a display shape.

Then, the second drawing processing unit 13 newly displays other information belonging to the same leaf category as the information indicated by the workable card serving as the target of the close operation as the workable card (step S78).

When the operation detection unit 14 detects the scroll operation as the user operation (NO in step S76 and YES in step S79), the second drawing processing unit 13 moves the card stack in conjunction with the display range of the tree structure of the category information (step S80). Here, when none of the close process and the scroll process is selected, the process ends (NO in step S76 and NO in step S79).

The processes included in the information display method according to the first exemplary embodiment is not limited to the order illustrated in FIG. 7, and the order may be changed as long as there is no problem in terms of content. For example, step S77 and step S78 may be performed in parallel. The order in which the detected user operations are determined (step S76 and step S79) may be changed.

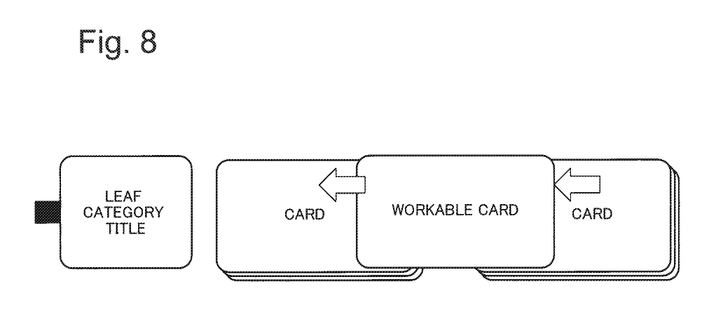

FIG. 8 is a diagram schematically illustrating an example of a part of information display according to the first exemplary embodiment. In FIG. 8, one leaf node and one card stack related to the leaf node are illustrated. In the example of FIG. 8, in step S77, the display position serving as the display form is changed. For example, when the state of the information updated by the input operation on the workable card is the work completion state, the card displayed as the workable card is moved onto the left card stack. Then, one card included in the right card stack is set as a new workable card.

(Operations and Effects of First Exemplary Embodiment)

In the first exemplary embodiment of the present invention, one of a plurality of information sets belonging to the leaf category is displayed as the workable card for each leaf category. Thereafter, when a predetermined operation on the workable card is detected, another card indicating other information belonging to the same leaf category as the information indicated by the workable card is newly set as the workable card. Thus, according to the first exemplary embodiment, when the user performs a predetermined operation on the workable card, next information is displayed as the workable card, and thus the user can notice information to access next absolutely and simply.

In the first exemplary embodiment of the present invention, when the display of the tree structure does not fall within the display area of the display unit 4, a part of the tree structure of the category information is displayed. As a result, the title of the leaf category displayed at each node in the tree structure is connected with the card stack displayed in association with the leaf category. In the tree structure display of the category information, when the number of categories is large, the entire tree structure does not fall within the display area of the display unit 4. In this case, as the display range of the tree structure is scrolled and moved, the card stack is moved in conjunction with the title of the leaf category.

Thus, according to the first exemplary embodiment, the correspondence relation between the leaf category and the card stack is easily understood. Further, in the first exemplary embodiment, since only the tree structure display of the category information can be a scroll target, a complicated scroll operation can be reduced. In other words, it is possible to provide the user interface technique capable of improving operability on information.

In addition, in the first exemplary embodiment, in the stacked display of each piece of information, the display form of the card indicating the information is changed according to the state of the information. Thus, the user can simply understand the state of each piece of information by viewing the display form of the card.

### Second Exemplary Embodiment

A smart device 10a according to a second exemplary embodiment can selectively set a card serving as the workable card in the stacked display of each piece of information. The smart device 10a according to the second exemplary embodiment will be described below focusing on different points from the first exemplary embodiment. In the following description, the same content as in the first exemplary embodiment will be appropriately omitted.

(Processing Configuration)

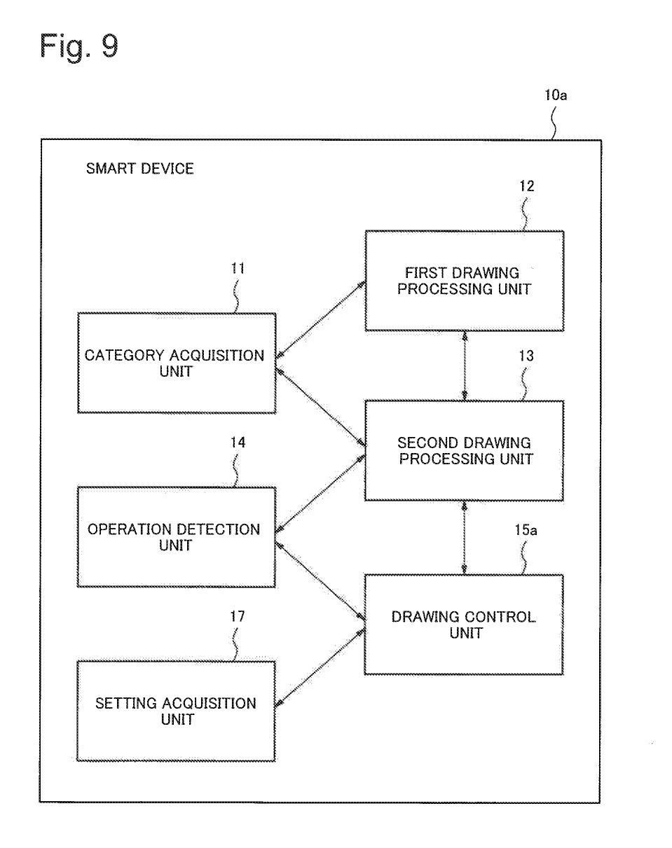

FIG. 9 is a diagram schematically illustrating an exemplary processing configuration of the smart device 10a according to the second exemplary embodiment. As illustrated in FIG. 9, the smart device 10a according to the second exemplary embodiment includes a category acquisition unit 11, a first drawing processing unit 12, a second drawing processing unit 13, an operation detection unit 14, a drawing control unit 15a, and a setting acquisition unit 17.

For at least one of a plurality of pieces of information displayed in the card format, the setting acquisition unit 17 acquires information specifying other information to be displayed as the workable card next and setting information including a selection condition of other information based on information inputtable to the at least one information. As the information specifying other information, an identifier (ID) that is uniquely allocated to all information may be used, or a number that is uniquely allocated to information belonging to the same leaf category may be used. Hereinafter, in order to avoid a redundant description, the “information specifying other information” is also referred to as an “ID of other information.” The selection condition may indicate an association between one of choices that are inputtable information and an IDs of other different information.

The drawing control unit 15a specifies information to be displayed as the workable card next among other information belonging to the same leaf category as the information indicated by the workable card based on the information indicated by the workable card and the setting information. Here, the information indicated by the workable card is information updated by the input operation detected by the operation detection unit 14. The setting information is information acquired by the setting acquisition unit 17. Specifically, the drawing control unit 15a specifies another card that matches the information updated by the input operation in the selection condition included in the setting information. The remaining units are the same as in the first exemplary embodiment, and a description thereof is omitted.

(Exemplary Operation)

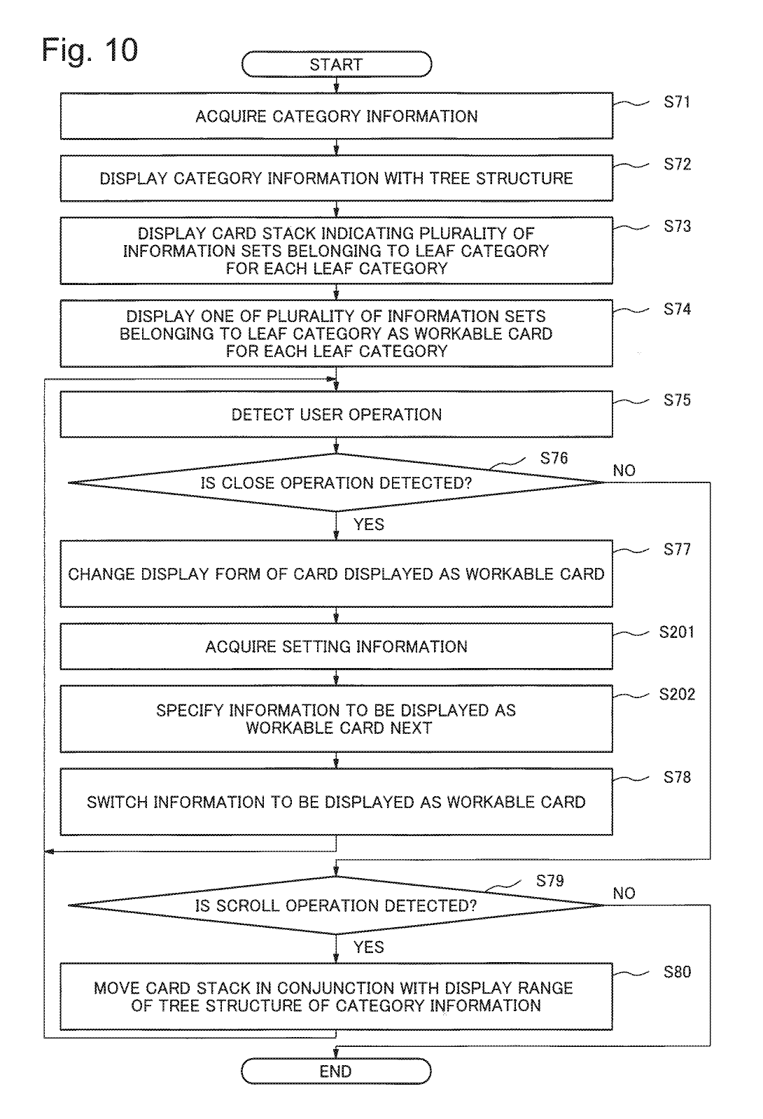

Next, an information display method according to the second exemplary embodiment of the present invention will be described with reference to FIG. 10. FIG. 10 is a flowchart illustrating a part of an exemplary operation of the smart device 10a according to the second exemplary embodiment. In FIG. 10, processes of the same content as in FIG. 7 are denoted by the same reference numerals as in FIG. 7. In the following description, an execution entity of each process is the smart device 10a, but each process may be performed by a plurality of computers including the smart device 10a. Each process is the same as the processing content of the processing units included in the smart device 10a, and thus a detailed process will be appropriately omitted.

In the smart device 10a, similarly to the first exemplary embodiment, when steps S71 to S77 are performed, the setting acquisition unit 17 acquires the setting information regarding the information indicated by the workable card (step S201). The setting information is information described above.

The drawing control unit 15a specifies information to be displayed as the workable card next among other information belonging to the same leaf category as the information indicated by the workable card based on the setting information acquired in step S201 and the information updated by the input operation on the workable card (step S202). The smart device 10a displays the information specified in step S202 as a next workable card (step S78).

The processes included in the information display method according to the second exemplary embodiment is not limited to the order illustrated in FIG. 10, and the order may be changed as long as there is no problem in terms of content. For example, step S201 may be performed at a point in time at which the workable card is decided in step S74 or step S78.

(Operations and Effects of Second Exemplary Embodiment)

As described above, in the second exemplary embodiment of the present invention, for at least one of a plurality of pieces of information displayed in the card format, the information specifying other information to be displayed as the workable card next and the setting information including the selection condition of other information based on information inputtable to the information are acquired. Further, information to be displayed as the workable card next is specified based on the acquired setting information and the information indicated by the workable card updated by the input operation.

Thus, according to the second exemplary embodiment of the present invention, it is possible not only to perform simple control such that a plurality of cards indicating a plurality of information sets belonging to the same leaf category are sequentially set as the workable card one by one but also to selectively set a card to be used as the workable card next based on the information updated by the input operation. Accordingly, it is possible to display only necessary information as the workable card according to the user's work without displaying unnecessary information. In other words, the user can recognize that information displayed as the workable card is all necessary information, and confusion or an erroneous input on an operation of the user can be reduced. That is, it is possible to provide the user interface technique capable of improving operability on information.

According to the second exemplary embodiment of the present invention, the following specific display transition can be performed. An example of an input operation on a card indicating payment method information will be described. For example, either of “full payment” and “financing” is selectable. When “full payment” is selected, payment period information is set as information to be displayed as the workable card next. When “financing” is selected, information indicating the number of times is set as information to be displayed as the workable card next. As another example, when an age input by the input operation on a card indicating age information is less than 20, guardian information may be set as information to be displayed as the workable card next, and when the age is 20 or more, information other than guardian information may be set as information to be displayed as the workable card next.

### Third Exemplary Embodiment

A drawing setting device and a drawing setting method, which are capable of performing a setting for processing of the smart devices 10 and 10a of the above-described exemplary embodiments will be described as a third exemplary embodiment of the present invention. In the third exemplary embodiment of the present invention, the drawing setting device is implemented as a device different from the information processing apparatus 100 and the smart devices 10 and 10a, but the drawing setting device may be implemented as the information processing apparatus 100 or the smart devices 10 and 10a.

(Device Configuration)

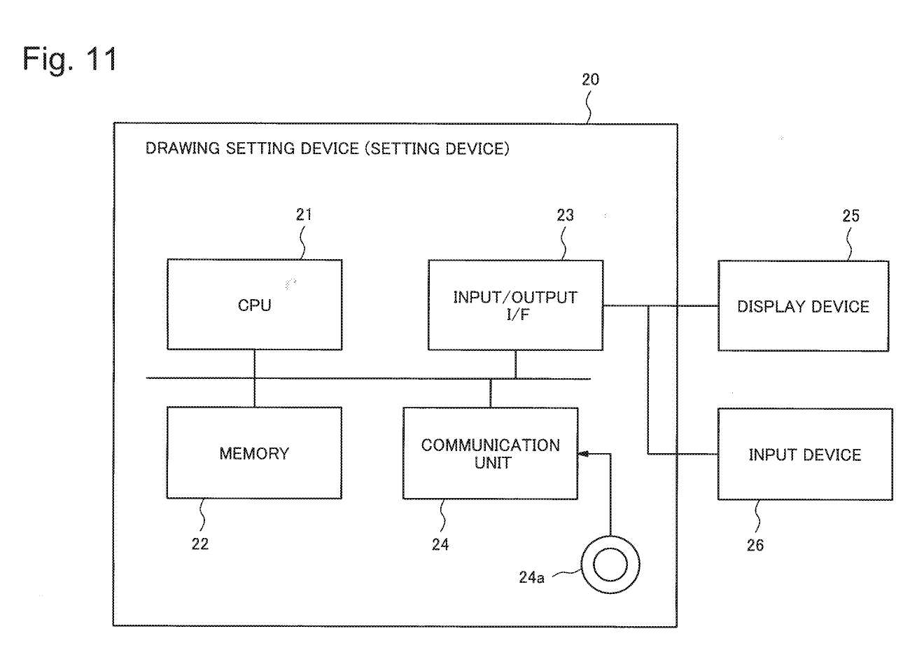

FIG. 11 is a diagram schematically illustrating an exemplary hardware configuration of a drawing setting device (hereinafter, also referred to simply as a “setting device”) 20 according to the third exemplary embodiment of the present invention. The setting device 20 is a computer, and includes, for example, a CPU 21, a memory 22, an input/output interface (hereinafter, “I/F”) 23, a communication unit 24, and the like which are connected to one another via a bus. The memory 22 includes a RAM, a ROM, a hard disk, or the like. The communication unit 24 exchanges a signal with another computer or device. A portable recording medium 24a or the like may be also connected to the communication unit 24.

The input/output I/F 23 is connectable with a user interface device such as a display device 25 or an input device 26. The display device 25 is a device that displays a screen related to drawing data processed by the CPU 21, a graphics processing unit (GPU) (not illustrated), or the like such as an LCD or a CRT display. The input device 26 is a device that receives an input of the user operation such as a keyboard or a mouse. The display device 25 and the input device 26 may be integrated and implemented as a touch panel. The hardware configuration of the setting device 20 is not limited.

The setting device 20 acquires information serving as the processing target from the information processing apparatus 100, the smart device 10, or another computer using communication or the like.

(Processing Configuration)

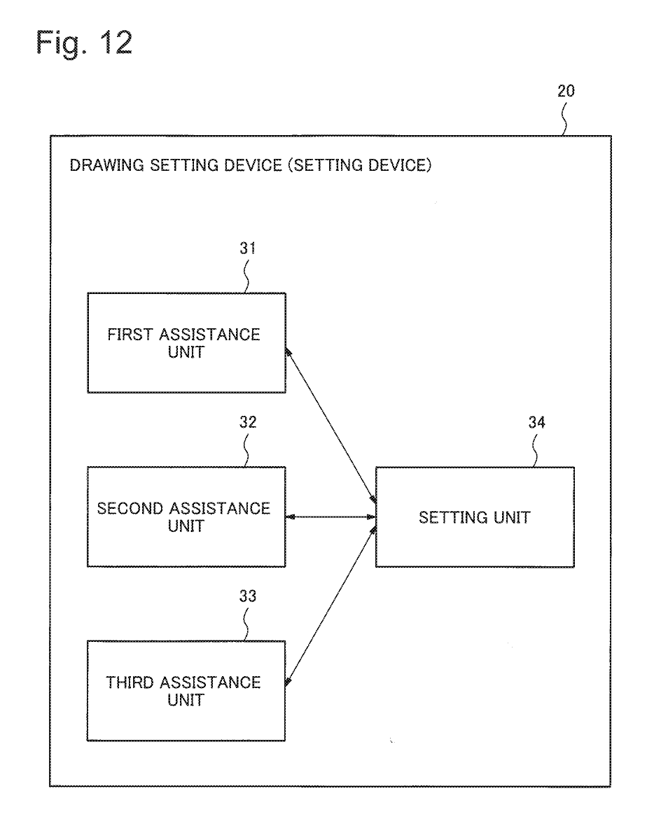

FIG. 12 is a diagram schematically illustrating an exemplary processing configuration of the drawing setting device 20 according to the third exemplary embodiment. The setting device 20 according to the third exemplary embodiment includes a first assistance unit 31, a second assistance unit 32, a third assistance unit 33, a setting unit 34, and the like. Each of the respective units is stored, for example, in the memory 22 as a program and implemented by appropriately executing the program through the CPU 21. For example, the program may be installed from a portable recording medium such as a compact disc (CD) or a memory card or another computer on a network via the input/output I/F 23 or the communication unit 24 and stored in the memory 22.

The first assistance unit 31 causes a first assistance screen for encouraging the user to set an association (hereinafter, referred to as “association information”) between each of a plurality of pieces of information displayed in the card format and the leaf category to which each piece of information belongs to be displayed on the display device 25. The first assistance screen may be formed so that the user can input a title of the leaf category to each piece of information or may be formed so that the user can visually associate each piece of information with each leaf category. A specific configuration of the first assistance screen is not limited.

The second assistance unit 32 causes a second assistance screen for encouraging the user to set an ID of other information to be displayed as the workable card next to each piece of information to be displayed on the display device 25. The second assistance unit 32 may cause the second assistance screen for encouraging the user to set IDs of a plurality of pieces of other information to be displayed as the workable card next to be displayed on the display device 25 for at least one piece of information. The second assistance screen may be formed so that the user can input the ID of other information to be displayed as the workable card next to each piece of information or may be formed so that the user can associate each piece of information with other information to be displayed as the workable card next. A specific configuration of the second assistance screen is not limited.

The third assistance unit 33 causes a third assistance screen for encouraging the user to set a selection condition of a plurality of pieces of other information to be displayed on the display device 25 for at least one piece of information to which IDs of a plurality of pieces of other information to be displayed as the workable card next are set. For example, the third assistance screen is formed to encourage the user to set a plurality of choices and an association between each of the choices and an ID of other information as the selection condition. The third assistance screen may be formed so that the user can set the selection condition for each ID of other information. A specific configuration of the third assistance screen is not limited.

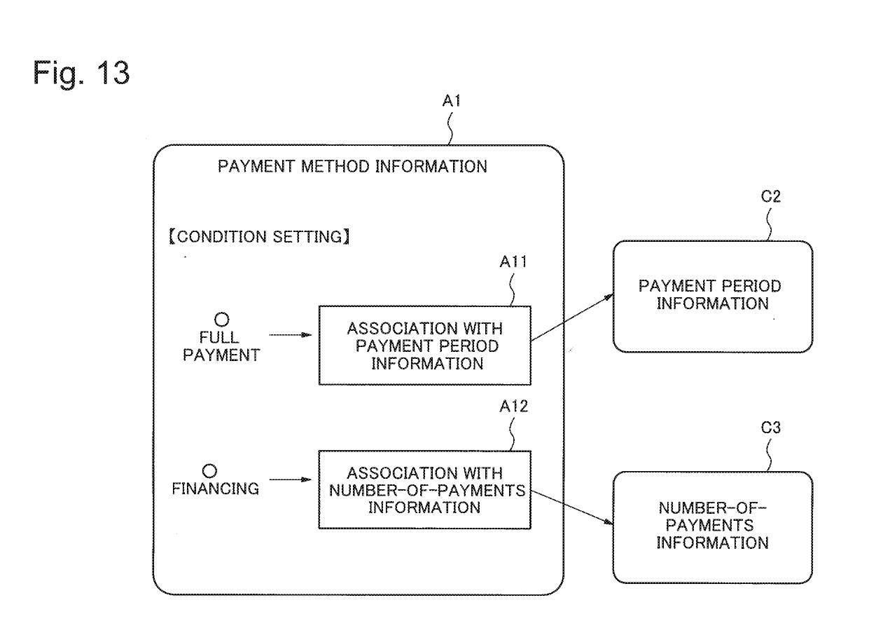

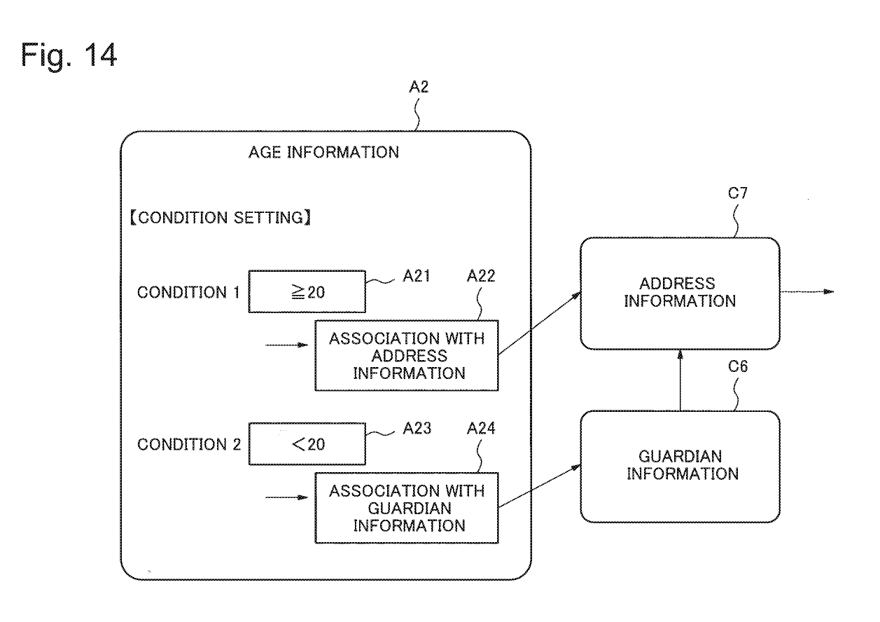

FIGS. 13 and 14 are diagram illustrating examples of an assistance screen in which the second assistance screen and the third assistance screen are integrated.

In a screen example illustrated in FIG. 13, in an integrated assistance screen A1, an ID of “payment period information” indicated by a card C2 and an ID of “number-of-payments information” indicated by a card C3 are set to choices of “full payment” and “financing” as the ID of other information to be displayed as the workable card next. According to the present example, the payment method information is displayed on the integrated assistance screen A1, and the screen is formed so that the user can input A11 and A12. Although not illustrated in FIG. 13, the integrated assistance screen A1 may be formed so that the user can input a choice such as “full payment” and “financing.”

In a screen example illustrated in FIG. 14, “address information” indicated by a card C7 is set as other information to be displayed as the workable card next for “guardian information” indicated by a card C6, and other information (not illustrated) is set for the “address information” indicated by the card C7. In the integrated assistance screen A2, condition information A21 and A23 is set as two selection conditions, and A22 indicating an ID of the “address information” and A24 indicating an ID of the “guardian information” are set as other information to be displayed as the workable card next, which relates to each piece of condition information (hereinafter, referred to as “next display information”). According to the present example, the integrated assistance screen A2 is formed so that the user can input A21, A22, A23, and A24.

The setting unit 34 causes the second drawing processing unit 13 to use the association information in the first assistance screen, and causes the drawing control unit 15 to use the next display information (A22 and A24) set in the second assistance screen. As a result, the second drawing processing unit 13 can cause a plurality of cards indicating a plurality of information sets belonging to the leaf category to be displayed in the stacked form based on the association information for each leaf category. Further, the drawing control unit 15 can specify information to be displayed as the workable card next based on the next display information. In order to cause each processing unit to use each piece of information, the setting unit 34 may transfer each piece of information to each processing unit or may store each piece of information in a memory which is referred to by each processing unit.

The setting unit 34 may cause the setting acquisition unit 17 to acquire the condition information set in the third assistance screen as the setting information. As a result, the drawing control unit 15 can specify information to be displayed as the workable card next based on the setting information acquired by the setting acquisition unit 17.

(Exemplary Operation)

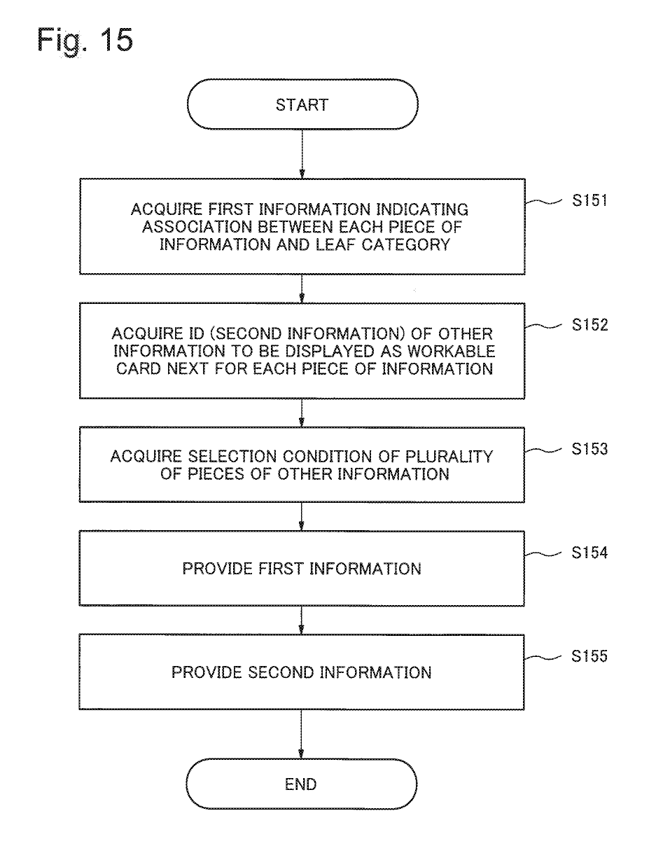

Next, a drawing setting method according to the third exemplary embodiment will be described with reference to FIG. 15. FIG. 15 is a flowchart illustrating an exemplary operation the drawing setting device 20 according to the third exemplary embodiment. In the following description, an execution entity of each process is the drawing setting device 20, but each process may be performed by a plurality of computers including the smart device 10 or the drawing setting device 20. Each process is the same as the processing content of the processing units included in the drawing setting device 20, and thus a detailed process will be appropriately omitted.

The first assistance unit 31 of the setting device 20 acquires first information (which is the same as the association information described above) indicating an association between each of a plurality of pieces of information displayed in the card format and the leaf category to which each piece of information belongs (step S151). For example, the first assistance unit 31 causes the first assistance screen to be displayed on the display device 25, and acquires the association information set by the user operation on the first assistance screen as the first information. The first assistance unit 31 may acquire the first information from another computer through communication or may acquire the first information from a portable recording medium.

Further, the second assistance unit 32 acquires an ID of at least one other information to be displayed the workable card next as second information (which is the same as the next display information described above) for each piece of information (step S152). For example, the second assistance unit 32 causes the second assistance screen to be displayed on the display device 25, and acquires the next display information set by the user operation on the second assistance screen as the second information. The second assistance unit 32 may acquire the second information from another computer through communication or may acquire the second information from a portable recording medium.

The third assistance unit 33 acquires the selection condition of a plurality of pieces of other information related to a plurality of IDs acquired in step S152 for information in which a plurality of IDs of other information are acquired as the second information in step S152 (step S153). In step S153, the third assistance unit 33 causes the second assistance screen and the third assistance screen or the integrated assistance screen to be displayed on the display device 25, and acquires the next display information and the selection condition set by the user operation on the assistance screen. The third assistance unit 33 may acquire the information from another computer through communication or may acquire the information from a portable recording medium.

The setting unit 34 provides the first information acquired in step S151 in order to specify a plurality of pieces of information for each leaf category in the information display method according to the exemplary embodiments (step S154). Further, the setting unit 34 provides the second information acquired in step S152 or the second information and the selection condition acquired in step S153 in order to specify other information to be newly displayed as the workable card in the information display method according to the exemplary embodiments (step S155).

An actual order of the drawing setting method according to the third exemplary embodiment is not limited to the order illustrated in FIG. 15. For example, step S154 and step S155 may be performed in an opposite order or may be performed in parallel. Step S151, step S152, and step S153 may be performed in parallel. Further, when there is no information in which IDs of a plurality of pieces of other information are set in step S152, step S153 may not be performed.

(Operations and Effects of Third Exemplary Embodiment)

In the third exemplary embodiment of the present invention, the information (the first information and the association information) indicating an association between each piece of information displayed in the card format and the leaf category to which the information belongs is acquired through the user input, communication, or the like. Thus, in the exemplary embodiments, it is possible to specify a plurality of pieces of information for each leaf category using this information. In the third exemplary embodiment of the present invention, the information (the second information and the next display information) specifying other information to be displayed as the workable card next is acquired through the user input, communication, or the like. Thus, in the exemplary embodiments, it is possible to specify information to be displayed as the workable card next using this information. Further, in the third exemplary embodiment of the present invention, for information in which a plurality of pieces of other information are set as information to be displayed as the workable card next, the selection condition of a plurality of pieces of other information is acquired through the user input, communication, or the like. Thus, in the second exemplary embodiment, it is possible to selectively decide information to be displayed as the workable card next according to input content to at least one piece of information using the information as the setting information.

As described above, according to the third exemplary embodiment of the present invention, it is possible to easily design and customize the information display in the card format in the exemplary embodiments. Accordingly, it is possible to provide the user interface technique capable of improving operability on information.

### Modified Examples of Exemplary Embodiments

As described above, for each leaf category, a plurality of cards indicating a plurality of information sets belonging to the leaf category are displayed in the stacked display form, and one of a plurality of pieces of information is displayed as the workable card. The input operation can be performed on the information indicated by the workable card. On the other hand, in the tree structure display of the category information, a plurality of leaf nodes are likely to be displayed, and each leaf node is displayed in conjunction with the card stack. In other words, there are cases in which a plurality of card stacks are displayed, and a plurality of workable cards are consequently displayed. In this case, the display area of the workable card is decreased, and thus it is likely to be difficult to perform the input operation on the workable card.

In this regard, the drawing control units 15 and 15a may cause the workable card itself to be enlarged and displayed or may cause an input assistance screen for assisting an input work on the information indicated by the workable card to be displayed separately from the workable card. In this case, it is possible to prevent the situation in which it is difficult to perform the input operation on the workable card even when a plurality of workable cards are displayed.

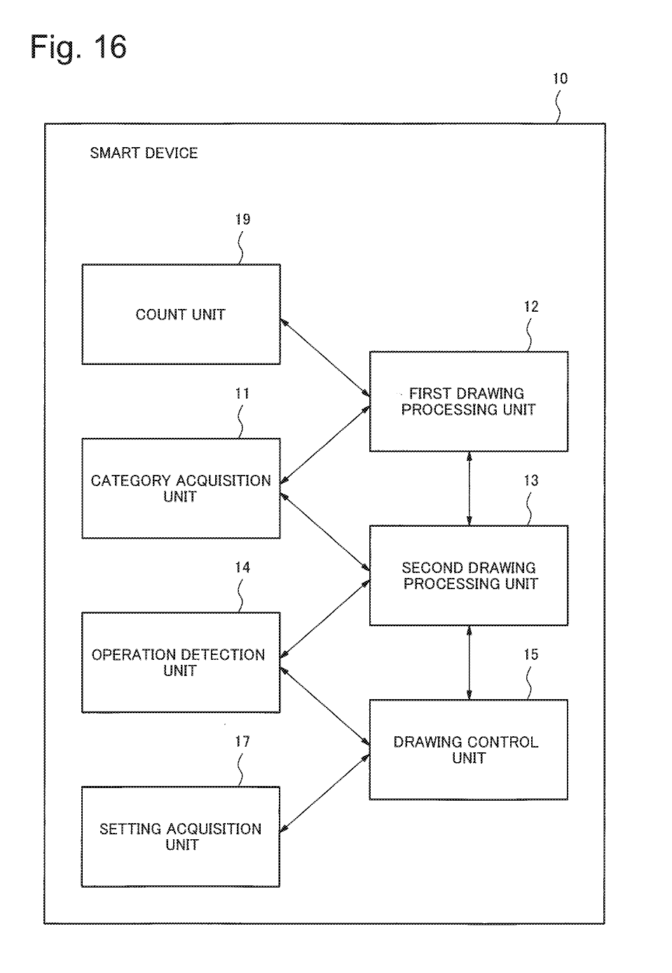

As described above, the display form of each of pieces of information displayed in the stacked form can be changed according to the state of the information. However, although the display form is changed, each card is displayed in the stacked form, and thus it is difficult to display the cards so that the user easily understands the number of cards whose display form is changed. In this regard, in the exemplary embodiments, the smart device 10 may have a processing configuration illustrated in FIG. 16.

FIG. 16 is a diagram schematically illustrating an exemplary processing configuration of a smart device 10 according to a modified example of the exemplary embodiments of the present invention. As illustrated in FIG. 16, the smart device 10 according to the modified example further includes a count unit 19 that acquires the total number of information displayed in the card format and the number of information in a specific state among the information displayed in the card format for each leaf category, in addition to the configuration of each of the exemplary embodiments. The count unit 19 is implemented, similarly to the other processing units.

The count unit 19 can acquire the total number by counting all information displayed in the card format. The count unit 19 can acquire the number of information in the specific state by determining the state of each piece of information. The count unit 19 can acquire the total number and the number of information in the specific state from another computer or a portable recording medium.

In this case, the first drawing processing unit 12 may cause the total number and the number of information in the specific state to be displayed on the display area of the leaf node including the title of the leaf category. The specific state refers to a state that is determined based on a change in the display form. Examples of the specific state include a non-completion state, a holding state, and a completion state.

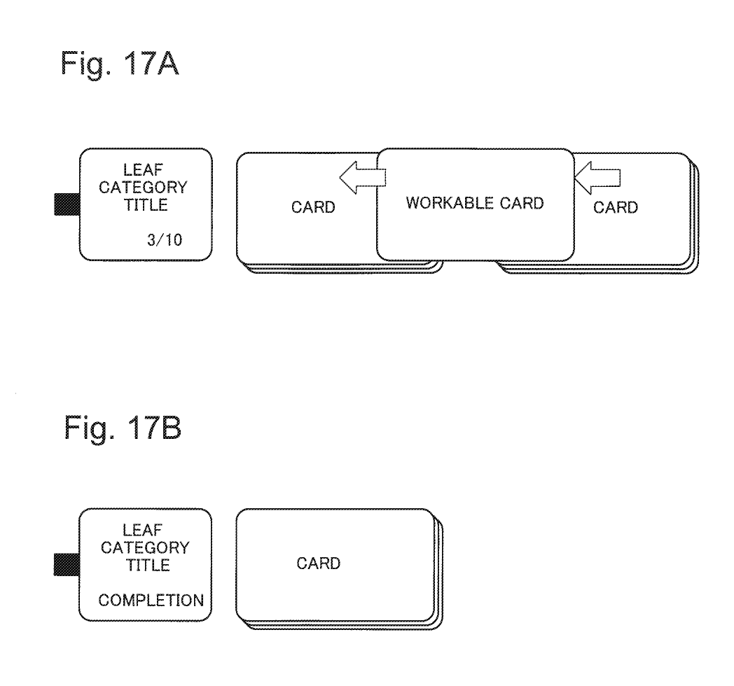

FIGS. 17A and 17B are diagrams schematically illustrating examples of a part of information display according to a modified example of the exemplary embodiments of the present invention. In an example illustrated in FIGS. 17A and 17B, the total number of information and the number of information in the specific state are displayed below the title of the leaf category. In the example of FIG. 17A, the total number of information and the number of information in the specific state are displayed using a fraction. In the example of FIG. 17B, “completion” is displayed. “Completion” indicates that all corresponding information enters the specific state. According to this modified example, it is possible to easily understand the total number of information belonging to the leaf category and the number of information in the specific state included in the information together with the title of the leaf category by viewing the display area of the leaf node.

As described above, according to the modified example of the exemplary embodiments of the present invention, it is possible to provide the user interface technique capable of improving operability on information.

Here, the information processing apparatus 100 and the smart devices 10 and 10a cause the information serving as the processing target in the exemplary embodiments, that is, each piece of information displayed in the card format to be held in the memory 3. The information processing apparatus 100 and the smart devices 10 and 10a may cause only information whose content is to be displayed as a card among all information serving as the processing target to be held in the memory 3 or may cause all information to be held in the memory 3. When only information whose content is to be displayed as a card is held in the memory 3, necessary information is acquired from another computer such as a server device.

The information processing apparatus 100 or the smart devices 10 and 10a may be implemented by a plurality of computers. When the information processing apparatus 100 or the smart devices 10 and 10a may be implemented by a plurality of computers, a computer including a device that detects the user operation such as the touch sensor 5 or the microphone unit 6 may be equipped with only the operation detection unit 14 or 104, and other computers may be equipped with the other processing units. Further, a certain computer may be equipped with only the operation detection unit 14 or 104 and the drawing control unit 15 or 105, and the other computers may be equipped with the other processing units.

In a plurality of flowcharts used in the above description, a plurality of processes are described in order, but the execution order of the processes performed in each of the present exemplary embodiments is not limited to the described order. In the present exemplary embodiments, the order of the processes illustrated in the drawings can be changed as long as there is no problem in terms of content. The exemplary embodiments may be combined as long as there is no contradiction in terms of content.

Some or all of the exemplary embodiments may be specified as follows. However, the exemplary embodiments are not limited to the following description.

### CLAIMS

### [Supplemental Note 1]

An information processing apparatus that causes each of a plurality of information sets serving as a processing target to be displayed on a display unit in a card format, comprising:

a category acquisition unit that acquires category information of the plurality of information sets serving as the processing target;

a first drawing processing unit that causes the category information to be displayed on the display unit with a tree structure in which at least one category is used as a node; and

a second drawing processing unit that causes a plurality of cards indicating a plurality of information sets belonging to a leaf category to be displayed in a stacked form, and causes one of the plurality of information sets belonging to the leaf category to be displayed as a workable card for each leaf category related to a leaf node in the tree structure.

### [Supplemental Note 2]

The information processing apparatus according to Supplemental Note 1,

wherein the first drawing processing unit causes a part of the tree structure of the category information to be displayed on the display unit, and

the second drawing processing unit connects a title of the leaf category displayed on the display unit with a card stack displayed in association with the leaf category.

### [Supplemental Note 3]

The information processing apparatus according to Supplemental Note 1 or 2,

wherein the second drawing processing unit changes a display form of the card according to a state of information set indicated by the card.

### [Supplemental Note 4]

The information processing apparatus according to any one of Supplemental Notes 1 to 3, further comprising,

a count unit that acquires the total number of information displayed in a card format and the number of information sets in a specific state among the information sets displayed in the card format for each leaf category,

wherein the first drawing processing unit causes the total number and the number of information sets in the specific state to be displayed on a display area of a leaf node including a title of the leaf category.

### [Supplemental Note 5]

The information processing apparatus according to any one of Supplemental Notes 1 to 4, further comprising:

an operation detection unit that detects a predetermined operation on the workable card; and

a drawing control unit that causes another information set belonging to the same leaf category as the information set indicated by the workable card to be newly displayed as the workable card as the predetermined operation is detected.

### [Supplemental Note 6]

The information processing apparatus according to Supplemental Note 5,

wherein the drawing control unit causes the workable card to be enlarged and displayed or causes an input assistance screen for assisting an input operation on information indicated by the workable card to be displayed separately from the workable card.

### [Supplemental Note 7]

The information processing apparatus according to Supplemental Note 5 or 6, further comprising,

a setting acquisition unit that acquires setting information including information specifying another information set to be displayed as the workable card next and a selection condition of another information based on information inputtable to at least one information set among a plurality of information sets displayed in a card format for the at least one information set,

wherein the drawing control unit specifies information to be displayed as the workable card next among other information belonging to the same leaf category as the information indicated by the workable card based on the information indicated by the workable card updated by an input operation detected by the operation detection unit and the setting information acquired by the setting acquisition unit.

### [Supplemental Note 8]

A drawing setting device, comprising:

a first assistance unit that causes a first assistance screen for encouraging a user to set an association between each of a plurality of information sets displayed in a card format and a leaf category to which each of the information sets belongs to be displayed on a display unit;

a second assistance unit that causes a second assistance screen for encouraging the user to set information specifying another information set to be displayed as a workable card next for each of the information sets to be displayed on the display unit; and

a setting unit that causes the second drawing processing unit to use association information set in the first assistance screen, and causes the drawing control unit to use display information set in the second assistance screen.

### [Supplemental Note 9]

A drawing setting device that assists a drawing setting of the information processing apparatus according to Supplemental Note 7, comprising:

a first assistance unit that causes a first assistance screen for encouraging a user to set an association between each of a plurality of information sets displayed in a card format and a leaf category to which each of the information sets belongs to be displayed on a display unit;

a second assistance unit that causes a second assistance screen for encouraging the user to set a plurality of pieces of information specifying a plurality of other information sets to be displayed as a workable card next for each of the information sets to be displayed on the display unit; and

a third assistance unit that causes a third assistance screen for encouraging the user to set a selection condition of a plurality of other information sets for at least one piece of information in which a plurality of information sets specifying the plurality of other information sets to be displayed as the workable card next are set to be displayed on the display unit; and

a setting unit that causes the second drawing processing unit to use association information set in the first assistance screen, and causes the setting acquisition unit to acquire next display information set in the second assistance screen and the condition information set in the third assistance screen as the setting information.

### [Supplemental Note 10]

An information display method executed by at least one computer that causes each piece of information serving as processing target to be displayed on a display unit in a card format, comprising:

acquiring category information of a plurality of information sets serving as the processing target;

causing the category information to be displayed on the display unit with a tree structure in which at least one category is used as a node;

displaying a plurality of cards indicating a plurality of information sets belonging to a leaf category in a stacked form for each leaf category related to a leaf node in the tree structure; and

displaying one of the plurality of information sets belonging to the leaf category as a workable card for each leaf category.

### [Supplemental Note 11]

The information processing method according to Supplemental Note 10, further comprising:

detecting a predetermined operation on the workable card; and

causing another information set belonging to the same leaf category as the information set indicated by the workable card to be newly displayed as the workable card as the predetermined operation is detected.

### [Supplemental Note 12]

The information processing method according to Supplemental Note 10 or 11, further comprising:

connecting a title of the leaf category displayed on the display unit with a card stack displayed in association with the leaf category.

### [Supplemental Note 13]

The information processing method according to any one of Supplemental Notes 10 to 12, further comprising:

changing a display form of the card according to a state of information set indicated by the card.

### [Supplemental Note 14]

The information processing method according to any one of Supplemental Notes 10 to 13, further comprising:

causing the workable card to be enlarged and displayed or causing an input assistance screen for assisting an input operation on information indicated by the workable card to be displayed separately from the workable card.

### [Supplemental Note 15]

The information processing method according to any one of Supplemental Notes 10 to 14, further comprising,

a count unit that acquires the total number of information displayed in a card format and the number of information sets in a specific state among the information sets displayed in the card format for each leaf category,

wherein the first drawing processing unit causes the total number and the number of information sets in the specific state to be displayed on a display area of a leaf node including a title of the leaf category.

### [Supplemental Note 16]

The information processing method according to any one of Supplemental Notes 10 to 15, further comprising,

acquiring setting information including information specifying another information set to be displayed as the workable card next and a selection condition of another information based on information inputtable to at least one information set among a plurality of information sets displayed in a card format for the at least one information set,

specifying information to be displayed as the workable card next among other information belonging to the same leaf category as the information indicated by the workable card based on the information indicated by the workable card updated by an input operation detected by the operation detection unit and the setting information acquired by the setting acquisition unit.

### [Supplemental Note 17]

A drawing setting method, comprising:

acquiring first information indicating an association of each of a plurality of information sets displayed in a card format and a leaf category to which each of the information sets belongs;

acquiring second information specifying another information set to be displayed as the workable car next for each of the information sets;

providing the first information as information specifying a plurality of information sets for each leaf category in the information display method; and

providing the second information as information specifying other information sets to be newly displayed as the workable card in the information display method.

### [Supplemental Note 18]

A drawing setting method in the information displaying method according to Supplemental Note 16, wherein

acquiring first information indicating an association of each of a plurality of information sets displayed in a card format and a leaf category to which each of the information sets belongs;

acquiring a plurality of second information specifiable a plurality of other information to be displayed as the workable card next, relating to at least one information from the plurality of information;

acquiring selection condition of the other plurality of information, relating to at least one of the information which has set a plurality of information specifiable a plurality of other information, to be displayed as the following workable card;

providing the first information as information specifying a plurality of information sets for each leaf category in the information display method; and

providing the selection condition and the second information, as information specifying other information sets to be displayed as the following workable card in the information display method.

### [Supplemental Note 19]

A recording medium storing a program that causes at least one computer to execute the information display method according to any one of Supplemental Notes 10-16.

### [Supplemental Note 20]

A recording medium storing a program that causes at least one computer to execute the drawing setting method according to Supplemental Note 17 or 18.

The present invention has been described using the above exemplary embodiments as exemplary examples. However, the present invention is not limited to the above exemplary embodiment. In other words, the present invention can have various aspects that can be understood by those skilled in the art within the scope of the present invention.

This application claims the benefit of Japanese Priority Patent Application No. 2014-037800 filed on Feb. 28, 2014, the entire contents of which are incorporated herein by reference.

### REFERENCE SIGNS LIST

2, 21 CPU
3, 22 memory
4 display unit
5 touch sensor
6 microphone unit
10 smart device
11, 101 category acquisition unit
12, 102 first drawing processing unit
13, 103 second drawing processing unit
14 operation detection unit
15, 15a drawing control unit
17 setting acquisition unit
19 count unit
20 drawing setting device (setting device)
23 input/output I/F
24 communication unit
24a portable recording medium
25 display device
26 input device
31 first assistance unit
32 second assistance unit
33 third assistance unit
34 setting unit
100 information processing apparatus

What is claimed is:

1.-13. (canceled)

14. An information processing apparatus that causes each of a plurality of information sets serving as a processing target to be displayed on a display in a card format, comprising:
a memory storing instructions; and
at least one processor configured to process the instructions to:
acquire category information of the plurality of information sets serving as the processing target;
cause the category information to be displayed on the display with a tree structure in which at least one category is used as a node; and
cause a plurality of cards indicating a plurality of information sets belonging to a leaf category to be displayed in a stacked form, and
cause one of the plurality of information sets belonging to the leaf category to be displayed as a workable card for each leaf category related to a leaf node in the tree structure.

15. The information processing apparatus according to claim 14, the processor further configured to:
cause, in the causing the category information, a part of the tree structure of the category information to be displayed on the display, and
in the causing the plurality of cards, connect a title of the leaf category displayed on the display with a card stack displayed in association with the leaf category.

16. The information processing apparatus according to claim 14, the processor further configured to:
in the causing the plurality of cards, change a display form of the card according to a state of information set indicated by the card.

17. The information processing apparatus according to claim 15, the processor further configured to:
in the causing the plurality of cards, change a display form of the card according to a state of information set indicated by the card.

18. The information processing apparatus according to claim 14, the processor further configured to:
acquire the total number of information displayed in a card format and the number of information sets in a specific state among the information sets displayed in the card format for each leaf category,
cause, in the causing the category information, total number and the number of information sets in the specific state to be displayed on a display area of a leaf node including a title of the leaf category.

19. The information processing apparatus according to claim 15, the processor further configured to:
acquire the total number of information displayed in a card format and the number of information sets in a specific state among the information sets displayed in the card format for each leaf category,
cause, in the causing the category information, total number and the number of information sets in the specific state to be displayed on a display area of a leaf node including a title of the leaf category.

20. The information processing apparatus according to claim 16, the processor further configured to:
acquire the total number of information displayed in a card format and the number of information sets in a specific state among the information sets displayed in the card format for each leaf category,
cause, in the causing the category information, total number and the number of information sets in the specific state to be displayed on a display area of a leaf node including a title of the leaf category.

21. The information processing apparatus according to claim 14, the processor further configured to:
detect a predetermined operation on the workable card; and
cause another information set belonging to the same leaf category as the information set indicated by the following workable card to be displayed as the workable card as the predetermined operation is detected.

22. The information processing apparatus according to claim 15, the processor further configured to:
detect a predetermined operation on the workable card; and
cause another information set belonging to the same leaf category as the information set indicated by the following workable card to be displayed as the workable card as the predetermined operation is detected.

23. The information processing apparatus according to claim 16, the processor further configured to:
detect a predetermined operation on the workable card; and
cause another information set belonging to the same leaf category as the information set indicated by the following workable card to be displayed as the workable card as the predetermined operation is detected.

24. The information processing apparatus according to claim 17, the processor further configured to:
detect a predetermined operation on the workable card; and
cause another information set belonging to the same leaf category as the information set indicated by the following workable card to be displayed as the workable card as the predetermined operation is detected.

25. The information processing apparatus according to claim 18, the processor further configured to:
in the causing another information, cause the workable card to be enlarged and displayed or cause an input assistance screen for assisting an input operation on information indicated by the workable card to be displayed separately from the workable card.

26. The information processing apparatus according to claim 18, the processor further configured to:
acquire setting information including information specifying another information set to be displayed as the following workable card and a selection condition of another information based on information inputtable to at least one information set among a plurality of information sets displayed in a card format for the at least one information set,
in the causing another information, specify information to be displayed as the following workable card among other information belonging to the same leaf category as the information indicated by the workable card based on the information indicated by the workable card updated by an input operation detected in the detecting a predetermined operation and the setting information acquired in the acquiring setting information.

27. The information processing apparatus according to claim 19, the processor further configured to:
acquire setting information including information specifying another information set to be displayed as the following workable card and a selection condition of another information based on information inputtable to at least one information set among a plurality of information sets displayed in a card format for the at least one information set,
in the causing another information, specify information to be displayed as the following workable card among other information belonging to the same leaf category as the information indicated by the workable card based on the information indicated by the workable card updated by an input operation detected in the detecting a predetermined operation and the setting information acquired in the acquiring setting information.

28. An information display method executed by at least one computer that causes each piece of information serving as processing target to be displayed on a display in a card format, comprising:
acquiring category information of a plurality of information sets serving as the processing target;
causing the category information to be displayed on the display with a tree structure in which at least one category is used as a node;
displaying a plurality of cards indicating a plurality of information sets belonging to a leaf category in a stacked form for each leaf category related to a leaf node in the tree structure; and
displaying one of the plurality of information sets belonging to the leaf category as a workable card for each leaf category.

29. A non-transitory computer readable recording medium storing a program that causes each piece of information serving as processing target to be displayed on a display in a card format, the program comprising:
acquiring category information of a plurality of information sets serving as the processing target;
causing the category information to be displayed on the display with a tree structure in which at least one category is used as a node;
displaying a plurality of cards indicating a plurality of information sets belonging to a leaf category in a stacked form for each leaf category related to a leaf node in the tree structure; and
displaying one of the plurality of information sets belonging to the leaf category as a workable card for each leaf category.
